(19) United States
(12) Patent Application Publication
(10) Pub. No.: US 2016/0150080 A1
(43) Pub. Date: May 26, 2016

(54) A URL TRANSMISSION SYSTEM AND MEANS THEREOF

(71) Applicant: Giora NADEL, Tel Aviv (IL)

(72) Inventor: Giora NADEL, Tel Aviv (IL)

(73) Assignee: Giora NADEL, Tel Aviv (IL)

(21) Appl. No.: 14/785,351

(22) PCT Filed: Apr. 23, 2014
(86) PCT No.: PCT/IL2014/050374

§ 371 Date: Oct. 19, 2015

Related U.S. Application Data
(60) Provisional application No. 61/815,269, filed on Apr. 24, 2013.

(51) Int. Cl. H04M 3/42; H04W 4/16; H04W 4/14; H04M 1/725

(52) U.S. Cl. CPC H04M 3/42076; H04M 1/72561; H04W 4/16; H04W 4/14; H04M 1/72552

(57) ABSTRACT

The present invention provides a uniform resource locator (URL) transmission system for displaying at least one predetermined URL comprising: (a) a smart phone having a phone call recognition system for recognizing and transmitting caller identification information; and, (b) a base station comprising a central processing unit (CPU) for transmitting telecommunication signals formatted as an active message. The CPU includes a computer readable medium containing instructions for automatically converting the recognized caller identification information to the active message, and instructions for automatically associating the active message to at least one predetermined URL associated with the receiver of the caller's transmission.

### CROSS REFERENCE

This application is a national phase of PCT Application Number PCT/IL2014/050374, filed on Apr. 23, 2014, which claims priority from provisional application No. 61/815,269, filed on Apr. 24, 2013. All of these applications are hereby incorporated by reference in their entirety.

### FIELD OF THE INVENTION

The present invention presents a Uniform Resource Locator (URL) transmission system for displaying at least one predetermined URL associated with the call receiver web site address. More particularly the system of the present invention delivers URL as an active message according to the preferences of the intended recipient of the call.

### BACKGROUND OF THE INVENTION

The world of mobile phone text messages provides various services and implementations.

SMS messages comprising URL addresses are common. There are a variety of systems which transmit SMS messages comprising different content and text. The mobile telecommunication systems permit access to variety of interfaces and websites of different companies, services and retails sources and data.

There are a variety of wireless web browser services for cellular phones and personal communication systems devices having a data service which connects a user's mobile station to the internet.

There is a long felt and unmet need to provide novel means and methods for an automatic and user-friendly interface transmission system of a website address and further customizing services implementation by the network.

### SUMMARY OF THE INVENTION

It is an object of the present invention to disclose a Uniform resource locator (URL) transmission system for displaying at least one predetermined URL comprising:

(a) a smart phone having a phone call recognition system for recognizing and transmitting caller identification information; and

(b) a base station comprising a central processing unit (CPU) for transmitting telecommunication signals formatted as an active message;

wherein said CPU comprising a computer readable medium containing instructions for automatically converting said recognized caller identification information to said active message, and instructions for automatically associating said active message to said predetermined URL associated with the receiver of said caller's transmission.

It is an object of the present invention to provide the system as defined above, wherein said base station including (a) data transmission means for transmitting data of a web page via a communication channel, and (b) character information transmission means for transmitting character information to said smart phone.

It is an object of the present invention to provide the system as defined above, wherein said character information is transmitted to said smart phone via a control channel or an IP platform.

It is an object of the present invention to provide the system as defined above, wherein said recognition system comprising IP call system.

It is an object of the present invention to provide the system as defined above, wherein said active message is transferred to a smart phone in a form selected from the group consisting of SMS, MMS, IM, IP based message and a combination thereof.

It is an object of the present invention to provide the system as defined above, wherein said URL is in a form of a link character used for accessing to a web page adjusted to the dialed number, such that said data transmission means transmits data of the whole said web page to a mobile station when the link character is selected.

It is an object of the present invention to provide the system as defined above, wherein the telecommunications signal is for reception by said smart phone which permit browsing of remote information resources such as a web page or web address.

It is an object of the present invention to provide the system as defined above, wherein the smart phone is adapted for browsing of remote information resources such as a web page; the smart phone further comprising means for receiving the active message and means for extracting and displaying the content summary for the one or more information resources.

It is an object of the present invention to provide the system as defined above, wherein the active message comprising a summary of the content of one or more information resources to which the smart phone is connected via an internet, and links specifying the location of each of the information resources.

It is an object of the present invention to provide the system as defined above, wherein the calls are derived from a utilized system to a cellular system.

It is an object of the present invention to provide the system as defined above, wherein the message further directs the user to a predetermined graphical user interface (GUI) providing video, audio picture, GPS or any related context to the URL.

It is an object of the present invention to provide the system as defined above, wherein the URL message allows an automatic opening of an active website such as pop up site.

It is an object of the present invention to provide the system as defined above, wherein transporting of the message is been performed in parallel to an executed phone call or immediately after phone call is ended.

It is an object of the present invention to provide a method for displaying at least one predetermined URL, comprising steps of:

(a) providing a Uniform resource locator (URL) transmission system for displaying at least one predetermined URL comprising:
i. a smart phone having a phone call recognition system for recognizing and transmitting caller identification information; and
ii. a base station comprising a central processing unit (CPU) for transmitting telecommunication signals formatted as an active message;

(b) executing a phone call from the smart phone to a distributor phone line;

(c) recognizing caller identification information;

(d) associating the distributor phone line to a predetermined URL; and

(e)transmitting the active message comprising the URL of the distributor website address;

wherein the method further comprising steps of instructing the CPU for automatically converting the recognized caller identification information to the active message;

further wherein instructing for automatically associating the active message to the predetermined URL associated with the receiver of the caller's transmission.

It is an object of the present invention to provide the method as defined above, wherein the method additionally comprising step of providing a base station including (a) data transmission means for transmitting data of a web page via a communication channel, and (b) character information transmission means for transmitting character information to the smart phone.

It is an object of the present invention to provide the method as defined above, the step of transmitting the active message further comprising step of transmitting character information to the smart phone via a control channel or an IP platform.

It is an object of the present invention to provide the method as defined above, wherein the method additionally comprising step of providing a recognition system including IP call system.

It is an object of the present invention to provide the method as defined above, wherein the method further comprising step of transmitting telecommunications signal in the form selected from the group consisting of SMS, MMS, IM, IP based message and a combination thereof.

It is an object of the present invention to provide the method as defined above, wherein the method further comprising step of sending the URL is in a form of a link character used for accessing to a web page adjusted to the dialed number, such that the data transmission means transmits data of the whole the web page to a mobile station when the link character is selected.

It is an object of the present invention to provide the method as defined above, wherein the telecommunications signal is received by the smart phone which further permits browsing of remote information resources such as web page links.

It is an object of the present invention to provide the method as defined above, wherein the browsing by the smart phone remote information resources comprising means for receiving the active message and means for extracting and displaying the content summary for the one or more information resources.

It is an object of the present invention to provide the method as defined above, wherein the message comprises a summary of the content of one or more information resources to which the smart phone is connected via an internet, and links specifying the location of each of the information resources.

It is an object of the present invention to provide the method as defined above, wherein the method further comprising step of deriving calls from any utilized system to a cellular system.

It is an object of the present invention to provide the method as defined above, wherein method further comprising step of directing the caller by the message to a predetermined GUI providing video, audio picture, GPS or a related interface or context to the URL.

It is an object of the present invention to provide the method as defined above, wherein the method further comprising step of providing the URL automatic opening of an active website in a form of a pop up site.

It is an object of the present invention to provide the method as defined above, wherein the step of transporting of the message is been performed in parallel to an executed phone call or immediately after the phone call is ended.

It is an object of the present invention to provide the method as defined above, wherein the method further comprising step of providing active message for a wireless receiver, comprising a pre-installed template.

### BRIEF DESCRIPTION OF THE DRAWINGS

In the following description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

The present invention provides novel means and methods for an automatic and user-friendly interface transmission system of a website address and further customization services implementation by the network.

In the accompanying drawing:

FIG. 1 presents a diagram illustrating the URL transmission system of the present invention;

FIG. 2 presents a flowchart illustrating a method of transmitting a URL, of the present invention;

FIG. 3 presents a flowchart illustrating a method of transmitting a URL, of the present invention; and,

FIG. 4 presents a flowchart illustrating the Rebound server processing unit of the present invention.

### DETAILED DESCRIPTION OF THE INVENTION

The following description is provided so as to enable any person skilled in the art to make use of the invention and sets forth the best modes contemplated by the inventor of carrying out this invention. Various modifications, however, will remain apparent to those skilled in the art, since the generic principles of the present invention have been defined specifically to provide system and method of transferring a Uniform Resource Locator (URL) associated with the phone call receiver.

The present invention have been defined specifically to provide a uniform resource locator (URL) transmission system and method for displaying a predetermined URL associated with the phone call receiver web site address. The system of the present invention delivers URL messages according to the preferences of an intended recipient.

The term ‘Active Message’, ‘character information transmission means’ Short Message Service (SMS)′, ‘ Instant messaging (IM)’, ‘ Multimedia Messaging Service (MMS)’, ‘Real-time message’ or ‘IP based message’ as used herein, refers to a text transmitted according to a predetermined content or context determined by a distributor. The text message may further be transmitted as it is being typed, created or at any desired or predefined time or event.

The text transmitted may be a text messaging service component of phone, Web, or any mobile communication systems or a character information transmission means for transmitting character information to a smart phone via a control channel or a communications protocol such as Internet Protocol (IP). The active message may further be transferred instantly and efficiently to a caller. The active message comprises a Uniform Resource Locator as a web address. The active message may provide data in a form of, by way of non-limiting example, an image, a picture, a video, a predefined text, a wed address link and any combination thereof.

The active message may further include technologies include TDD/TTY devices for the deaf, live captioning for TV, a feature enhancement in instant messaging, captioning for telephony/video teleconferencing, telecommunications relay services including IP-relay, transcription services including Remote CART, TypeWell, collaborative text editing, streaming text applications and next-generation emergency service.

The term ‘mobile phone’, ‘smart phone’ cellular phone′, ‘cell phone’, ‘hand phone’ or ‘land line phone’ as used herein, refers to any phone means as a telecommunications device that permits two or more users to conduct a conversation when they are not in the same vicinity of each other to be heard directly or one that can make and receive telephone calls over a radio link while moving around a wide geographic area.

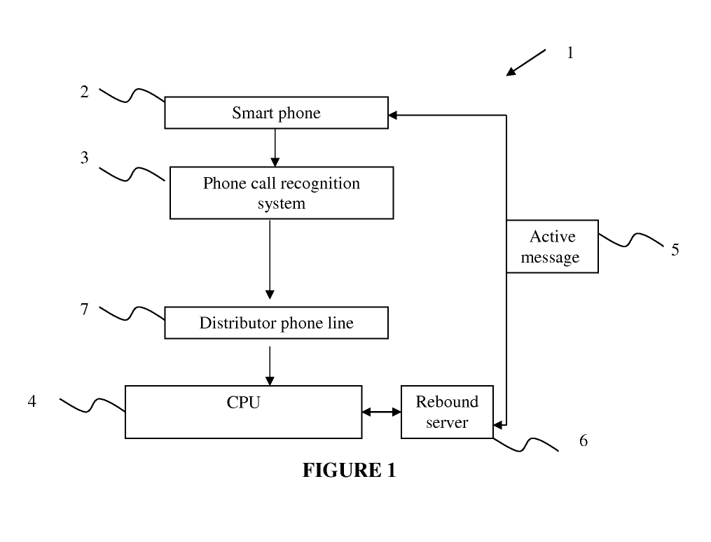

The phone means converts sound into electronic signals suitable for transmission via cables or other transmission media over long distances, and replays such signals simultaneously in audible form to its user. The phone means may also support a wide variety of other services such as text messaging, MMS, IM, IP platform, email, Internet access, short-range wireless communications (infrared, Bluetooth), business applications, gaming photography, video, images, applications and additional general computing capabilities. Reference is now made to FIG. 1 which illustrates a uniform resource locator (URL) transmission system 1 for displaying at least one predetermined URL comprising: (a) a smart phone 2 having a phone call recognition system for recognizing and transmitting caller identification information; and (b) a base station comprising a central processing unit (CPU) 4 for transmitting telecommunication signals formatted as an active message. The CPU includes a computer readable medium containing instructions for automatically converting the recognized caller identification information to an active message, and instructions for automatically associating the active message to a predetermined URL message 5 associated with the receiver of the caller's transmission.

The system of the present invention is with the ability to route an incoming and/or outgoing telephone calls to a URL associated with the phone call receiver/distributor 7 designated web site address.

The system of the present invention identifies a respective (calling) subscriber terminal and displays automatically a URL address as an active message, which comprises the stored information describing the receiver accepting the incoming call. The system of the present invention comprises a base station comprising: (a) data transmission means for transmitting data of the call receiver web page via a communication channel, and (b) character information transmission means for transmitting character information to a smart phone. The character information may further be transferred to a mobile phone via a control channel or an IP platform.

The system further comprises a recognition system such as an IP call system.

The recognition system may be at the level of a user local center or at the level of the phone company supply or services.

The base station further comprises a designated server, with appropriate algorithms on computer readable media, a “Rebound server” 6, for transmitting active message such as SMS, MMS POP-UP, IM messages or IP based message which may be in communication with the phone call receiver.

In another embodiment of the present invention, the system is based upon at least one of the following processes verification, certification, authentication and validation. Each of these processes may be a sub process of the other or an independent process of the present invention system. The level of verification, or number of times the producer's data is verified against is not limited and relies upon the user's actions and inputs. The Authentication platform may be configured to present both a public identifier such as a user name or identification number and private authentication information, such as a Personal Identification Number (PIN), password, or information derived from a cryptographic key.

In another embodiment of the present invention, the Rebound server can be a local server of the call receiver or the URL distributor, or an external server of a landline phone company, Cellular Phone Company or any other phone line supplier. A phone call receiver may be a distributor or a supplier such as a commercial company a professional firm or any retail company, or as a cloud computing service. Cloud computing may further be combined with mobile networks resulting in mobile cloud computing to bring benefits for mobile users, network operators, as well as cloud providers. Cloud computing provides on-demand access. The applications are run on a remote server and then sent to the user. The mobile cloud computing will provide companies with opportunities to connect with mobile network providers in a seamless and convenient manner.

In another embodiment of the present invention, the server is selected from the group consisting of a web server in the internet content region, an exchange server in the public switch region and a main server in a wireless carrier region. The server may include a template for summarizing web page content and generating a web content summary page in the short message service format.

The base station comprises a Rebound server for connecting and directing messages. The Rebound server may further include all the data base, output and input of the system and the direction and distribution implementation of the system. The data base collects and stores the distributors information and identification data, which transmits an internet web page address in the form of a URL link and further the consumers caller information and identification data and information.

The Rebound server may further include other varieties of content messages which the distributors will decide to transfer to the customer caller. The Rebound server may further be configured and may further act in a cookie like manner.

The server may further be activated automatically on every incoming call received from a smart phone according to a predetermined protocol.

The system may further convert any cellular phone call as a part of a commercial, publicity or public relations loop based on the internet, web and technologies.

The messages are transferred to the customer which has called to the distribution company from its own initiative.

In another embodiment of the present invention, the active message is transferred to a smart phone in a format selected from the group consisting of SMS, MMS, IM, IP based message and a combination thereof.

In another embodiment of the present invention, the URL is in a form of a link character used for accessing to a web page adjusted to the dialed number, such that the data transmission means transmits data of the whole web page to the mobile station when the link character is selected. Therefore a specific Internet address is automatically displayed.

The term “uniform resource locator” or “URL”, used herein, refers to a web address which has specific character string that constitutes a reference to a resource. The URL may be technically in the form of uniform resource identifier (URI), or used as a synonym for URI.

The transmitted URL message consists of the following: the scheme name, followed by a colon, two slashes then, depending on scheme, a server name followed by a dot then a domain name (alternatively, IP address), a port number, the path of the resource to be fetched or the program to be run, then, for programs such as Common Gateway Interface (CGI) scripts, a query string, and an optional fragment identifier. The scheme name will define the namespace, purpose, and the syntax of the remaining part of the URL. The system software will process the URL according to its scheme and context. The domain name or IP address will give the destination location for the URL. The path further specifies and finds the resource requested. It is case-sensitive, though it may be treated as case-insensitive by some servers. The URL contains and/or points to an information of the phone call receiver.

In another embodiment of the present invention, the telecommunications signal is for reception by the smart phone for further permitting browsing of remote information resources such as web pages or the like.

In another embodiment of the present invention, the URL provides a snapshot indication of where in the hypertext environment of the organization's WWW services the user is at a given time.

In another embodiment of the present invention, the mobile phone is adapted for browsing of remote information resources such as web pages or the like comprising means for receiving an active message and means for extracting and displaying the content summary for the one or more information resources. The system further identifies the source of the incoming phone call such as a land line phone or a mobile phone. The rebound server recognizes the source of the incoming phone call and instructs the smart phone to import an URL as an active text message related to the call receiver. The message comprises a summary of the content of one or more information resources to which the smart phone can connect via an internet, and links specifying the location of each of the information resources. The phone calls may be derived from any utilized system to a cellular system.

In another embodiment of the present invention, the incoming message may further direct the user to a predetermined smart phone application platform such as graphical user interface (GUI) providing video, audio picture, or any other interface related to the company/retail web address.

The URL message allows an automatic opening of an active site such as a pop-up site.

The transporting of the message is performed in parallel to an executed phone call or immediately after the incoming phone call has ended.

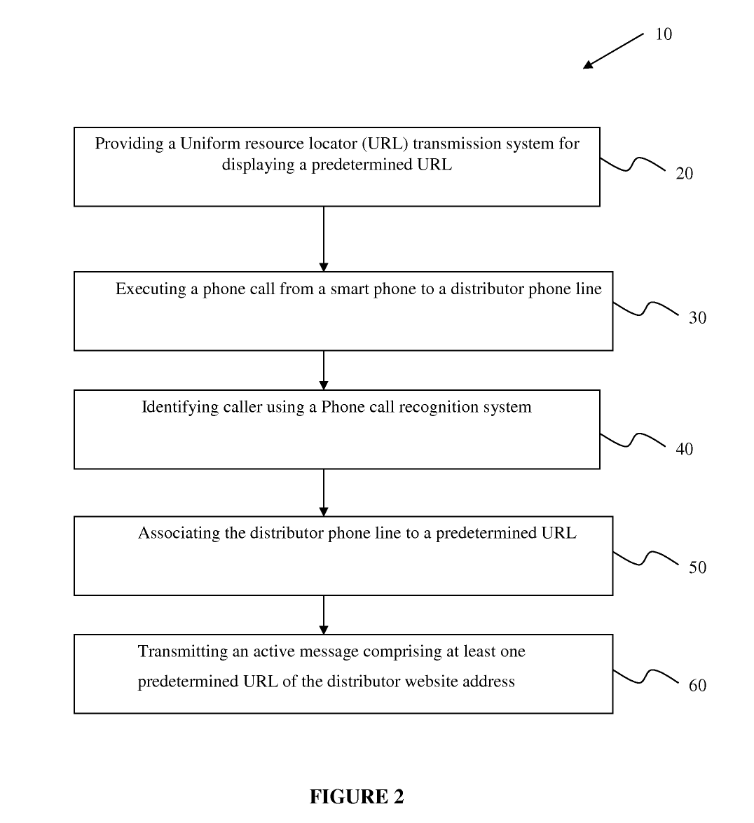

Reference is now made to FIG. 2 which presents a method for displaying a URL 10, comprising the step of: (a) providing a Uniform resource locator (URL) transmission system for displaying a predetermined (URL), 20 comprising:

(i) a smart phone having a phone call recognition system for recognizing and transmitting caller identification information; and (ii) a base station comprising a CPU for transmitting telecommunication signals formatted as an active message,

(b) executing a phone call from the smart phone to a distributor phone line 30,

(c) recognizing caller identification information 40, (d) associating the distributor phone line to a predetermined URL 50, and transmitting the active message comprising the URL of the distributor website address 60.

The method provides a system which identifies a respective (calling) subscriber terminal and automatically displays a URL address as an active message, which comprises the stored information describing the receiver accepting the incoming call. The method further comprises step of obtaining a computer readable medium for instructing the automatic conversion of the recognized caller identification information to the active message. In some embodiments of the method the instructions for automatically associating the active message to a predetermined (URL) are associated with the receiver of the caller's transmission.

In another embodiment of the invention the method is disclosed as described above, wherein the method further provides a base station including (a) data transmission means for transmitting data of a web page via a communication channel, and (b) character information transmission means for transmitting character information to the smart phone. The character information may further be transferred via a control channel or as an IP based text message.

In another embodiment of the invention the method is disclosed as described above, wherein the method further providing a recognition system including IP call system.

In another embodiment of the invention the method as described above, wherein the method further comprising the step of transmitting telecommunications signal to the smart phone as an active message selected from the group consisting of SMS, MMS, IM, IP based message and a combination thereof.

In another embodiment of the invention the method is disclosed as described above, wherein the method further comprising the step of sending the URL is in a form of a link character used for accessing to a web page adjusted to the dialed number, such that the data transmission means transmits data of the whole web page to the mobile station when the link character is selected.

In another embodiment of the invention the method is disclosed as described above, wherein the telecommunications signal is for receipt by the smart phone which further permits browsing of remote information resources such as web pages or the like.

In another embodiment of the invention the method is disclosed as described above, wherein the method further comprises the step of browsing by the mobile phone remote information resources such as web pages or the like. The information resources comprise means for receiving an active message and means for extracting and displaying the content summary for the one or more information resources.

In another embodiment of the invention the method is disclosed as described above, wherein the message comprises a summary of the content of one or more information resources to which the smart phone can connect via an internet link, specifying the location of each of the information resources.

In another embodiment of the invention the method is disclosed as described above, wherein the method further comprises the step of deriving calls from any utilized system to a cellular system.

In another embodiment of the invention the method is disclosed as described above, wherein method further comprises the step of directing the caller by the message to a predetermined GUI providing video, audio picture or any related context to the URL.

In another embodiment of the invention the method is disclosed as described above, wherein the method further providing a URL automatic opening of an active site in a form of a pop up site.

In another embodiment of the invention the method is disclosed as described above, wherein the step of transporting of the message is been performed in parallel to an executed phone call or immediately after phone call is ended.

In another embodiment of the invention the method is disclosed as described above, wherein the method further comprises the step of providing short message service for a wireless receiver, comprising: a pre-installed template.

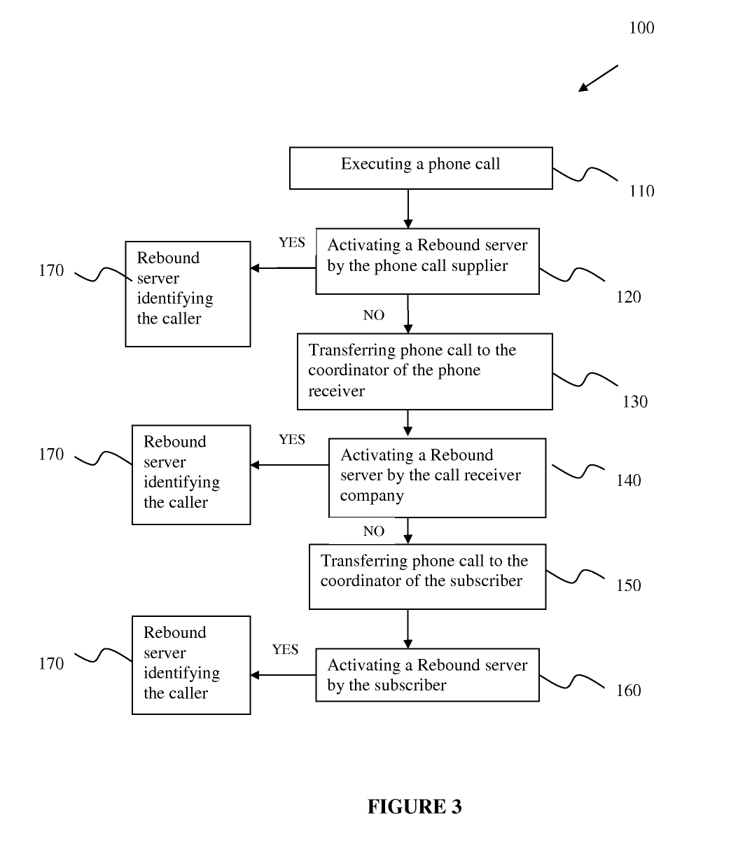

Reference is now made to FIG. 3 which presents a flow chart of the method and the path of the executed phone call until a URL message is transmitted to a smart phone device 100.

The phone call can be executed from a smart phone or an IP phone 110. The Rebound server can be connected or located to the phone caller distributor or supplier such as a cellular company which activates the rebound server 120. The Rebound server then receives the caller identification 170 and transmits URL massage to the smart phone of the caller.

If the phone call supplier is not connected to a Rebound server the phone call is transferred to the coordinator which accepts the call 130. The coordinator which accepts the phone call such as a land line company 140, can be connected to a rebound server, the rebound server then receives the caller identification 170 and transmits URL massage to the smart phone of the caller.

If the coordinator which accepts the phone call is not connected to the rebound server, the call is transferred to the coordinator of the subscriber 150. The coordinator of the subscriber can be a retail company or the like, which is related to the transmitted URL. If the subscriber is connected to a rebound server 160, the rebound server then receives the caller identification 170 and transmits URL massage to the smart phone of the caller.

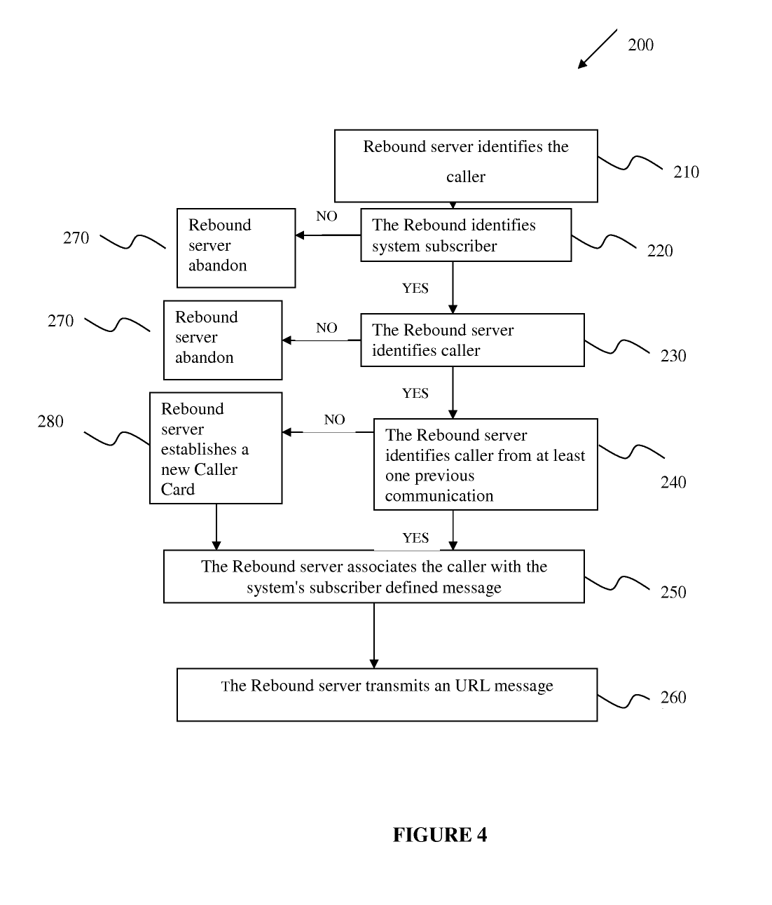

Reference is now made to FIG. 4 which presents the “Rebound server” processing unit and function 200, of the present invention. The Rebound server is adapted as a central processor unit which performs arithmetic and logical operations, and extracts instructions from memory and decodes and executes them. The server further acts as a data processing unit. The processing may be automated and run on the server. It involves recording, analyzing, sorting, summarizing, calculating, disseminating and storing data. The Rebound server typically manipulate raw data into information, and take the raw data received as input and produce the information as output such as SMS, IM messages, URL messages or/and IP messages which may be in communication with the phone call receiver.

The Rebound server of the present invention receives the incoming call and identities the caller 210. The server further recognizes and attributes the caller 230 and the subscriber (the phone call receiver) 220 of the Uniform resource locator (URL) transmission system. If the caller is already known by the system 240. The server identifies the caller phone number or IP according to a ‘caller card’. Furthermore, the server recognizes if the caller is a new client of the system. If the caller identification data is already restored in the system the server recognize the caller and automatically locates the adjustable message for transmission. If the caller is a new client of the system, the server establishes a new caller Id card in the system 280. If the server does not identifies or contain any data upon the caller or/and the subscriber, the server abandons 270.

After the system identifies the caller and subscriber, the server associates the caller with the system's subscriber messages 250 and further transmits a defined URL message associated with the subscriber 260.

The ‘subscriber card’ is defined in the system by the phone number related to the phone call receiver which is a specific client registered to the URL transmission system. The phone number may be a landline number, a cellular number, IP number and combination thereof.

The ‘subscriber card’ comprises all the client data which is stored and collected from previous communications. The subscriber, using an authorized enter code or password, has the ability to enter to the system preference and data stored and to manage and to assert the transmitted messages by content, transmitted time, type and design of the transmitted messages.

The ‘caller card’ is defined by the caller phone number which may be a landline number, a cellular number, IP number and combination thereof.

The URL transmission system comprises a basic caller card which is established automatically when a first call is been performed by the caller. The ‘caller card’ may comprise all the data and information related to the specific caller. The ‘caller card’ is been attributed to at least one subscriber. The caller, using an authorized code or password, may further partially manage the transmitted messages within its ‘caller card’.

In another embodiment of the present invention, the Uniform resource locator (URL) transmission system of the present invention may further provide at least one channel or a station for delivering an URL message according to the preferences of an intended recipient.

The URL message provides an automatic information or data of the supplier, e.g. call receiver, which is transmitted directly to the caller resulting from his dialing action.

The URL transmission system may further be connected to a landline phone, smart phone, a fax system, an email system or a combination thereof. The URL system comprising a rebound server is further activated following a dialing step to at least one predefined line such as a landline phone, a smart phone, a fax system, or an email system of the distributor or supplier. The supplier may further provide a URL message comprising a variety of information and data such as the supplier website, a desired location, a web page or a designated phone number which further allows the caller to connect with the supplier. The URL transmission system comprising a Rebound server provides a Rebound line which is further configured as a trigger for activating the URL transmission and thus will allow the supplier's phone line to be available and not busy to other callers.

### EXAMPLES

### Example 1

A caller using a smart phone connects with a distributor or supplier having a call routing system which comprises multiple exchanges (e.g. Routing in the PSTN). Telephone calls can be routed across a network of multiple exchanges, potentially owned by different telephone carriers. The exchanges are all connected using trunks. Each exchange has many “neighbors”, some of which are also owned by the same telephone operator, and some of which are owned by different operators. When neighboring exchanges are owned by different operators, they are known as interconnect points. This means that there is one virtual network in the world that enables any phone to call any other phone. This virtual network comprises many interconnected operators, each with their own exchange network. Every operator can then route calls directly to their own customers, or pass them on to another operator if the call is not for one of their customers.

The call routing system is not a fully meshed network with every operator connected to every other that would be both impractical and inefficient. Therefore calls may be routed through intermediate operator networks before they reach their final destination. One of the major problems in call routing system is determining how to route this call in the most cost effective and timely manner.

The routing system of the call receiver such as a distributor or supplier connected to the Uniform resource locator (URL) transmission system of the present invention comprising the Rebound server which is further routing the caller in a more quick, efficient and effective manner.

The Rebound server recognizing the caller number and delivers at least one URL using MMS, SMS, IM or IP based message platform. The URL comprises maps the routing system extensions in a tree structure (data structure) format such as a diagram, a menu, a taskbar or a flow chart comprising different push buttons enabling the caller to reach in the most cost effective and timely manner to the desired extension by selecting the desired extension in advance. This further prevents the caller from waiting on line and further activating an interactive voice response (IVR). Alternatively, the URL may further appear in a pop up platform display such as a graphical user interface optionally, having interactive effects. The system may further transmit an additional direct URL to the caller in the caller's preselected extension.

### Example 2

A phone call executes from a communication system in the caller's vehicle which further based upon a Unix-like active operating system (QNX) or windows operating system. The communication system in the caller's vehicle is configured as a smart phone or a tablet both in the content, function and presentation such as a clever touchscreen, knobs, dials, keyboard, touch buttons or external push/press buttons. The call receiver's URL transmission system of the present invention delivers an URL as a pop-up display or as an MMS, SMS, IM or IP based message directly to the communication system in the caller's vehicle.

The caller may further use the transmitted URL according the implementation of the communication system in the caller's vehicle.

### Example 3

A phone call executes from a smart phone to a distributor or supplier having the URL transmission system of the present invention. The system receiving the phone call transmit a URL comprising a navigation or a location/geographic coordinate which provides location and time information respectively. Thus, the caller receives a URL which may further activate the navigation system such as a mapping system or Global Positioning System (GPS), space-based satellite navigation system.

### Example 4

A phone call executes from a smart phone to a supplier (such as a restaurant, a cinema a concert or the like) having the URL transmission system of the present invention. The system receiving the phone call transmit a URL comprising a form or a page for place invitation. The caller may further confirm the invitation and transmit an approval directly to the supplier (e.g. the call receiver).

The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1-27. (canceled)

28. A Uniform resource locator (URL) transmission system for displaying at least one predetermined URL to a caller comprising:
a. a smart phone having a phone call recognition system for recognizing and transmitting said caller identification information; and
b. a base station comprising a central processing unit (CPU) for transmitting telecommunication signals formatted as an active message;
wherein said CPU comprising a computer readable medium containing instructions for automatically converting said recognized caller identification information to said active message, and instructions for automatically associating said active message to said predetermined URL associated with the receiver of said caller's transmission thereby, said caller receives automatically said active message comprising said URL which directs to a receiver web page in parallel to an executed phone call or after phone call is ended.

29. The system according to claim 28, wherein said base station including data transmission means for transmitting data of a web page via a communication channel.

30. The system according to claim 28, wherein said URL is transmitted to said smart phone via a control channel or an IP platform.

31. The system according to claim 28, wherein said recognition system comprising IP call system.

32. The system according to claim 28, wherein said active message is transferred to a smart phone in a form selected from the group consisting of SMS, MMS, IM, IP based message and a combination thereof.

33. The system according to claim 28, wherein said URL is in a form of a link character used for accessing a web page adjusted to the dialed number, such that said data transmission means transmits data of the whole said web page to a mobile station when the link character is selected.

34. The system according to claim 28, wherein said telecommunications signal is for reception by said smart phone which permit browsing of remote information resources such as a web page or web address.

35. The system according to claim 28, wherein said smart phone is adapted for browsing of remote information resources such as a web page; said smart phone further comprising means for receiving said active message and means for extracting and displaying said content summary for said one or more information resources.

36. The system according to claim 28, wherein said active message comprising a summary of the content of one or more information resources to which said smart phone is connected via an internet, and links specifying the location of each of said information resources.

37. The system according to claim 28, wherein said calls are derived from a utilized system to a cellular system.

38. The system according to claim 28, wherein said message further directs the user to a predetermined graphical user interface (GUI) providing video, audio picture, GPS or any related context to said URL.

39. The system according to claim 28, wherein said URL message allows an automatic opening of an active website such as pop up site.

40. A method for displaying at least one predetermined URL to a caller, comprising steps of:
a. providing a Uniform resource locator (URL) transmission system for displaying at least one predetermined URL comprising:
i. a smart phone having a phone call recognition system for recognizing and transmitting caller identification information; and
ii. a base station comprising a central processing unit (CPU) for transmitting telecommunication signals formatted as an active message;
b. executing a phone call from said smart phone to a distributor phone line;
c. recognizing caller identification information;
d. associating said distributor phone line to a predetermined URL; and
e. transmitting said active message comprising said URL of the distributor website address;
wherein said method further comprising steps of instructing said CPU for automatically converting said recognized caller identification information to said active message; said instructing for automatically associating said active message to said predetermined URL associated with the receiver of said caller's transmission thereby, automatically transmitting said active message comprising said URL which directs to receiver web page in parallel to an executed phone call or after phone call is ended.

41. The method according to claim 40, wherein at least one of the following holds true:
a. said method additionally comprising step of providing a base station including data transmission means for transmitting data of a web page via a communication channel; and
b. said step of transmitting said active message further comprising step of transmitting said URL to said smart phone via a control channel or an IP platform.

42. The method according to claim 40, wherein at least one of the following holds true:
a. said method additionally comprising step of providing a recognition system including IP call system; and
b. said method further comprising step of transmitting telecommunications signal in the form selected from the group consisting of SMS, MMS, IM, IP based message and a combination thereof; and
c. said method further comprising step of sending said URL is in a form of a link character used for accessing a web page adjusted to the dialed number, such that said data transmission means transmits data of the whole said web page to a mobile station when the link character is selected.

43. The method according to claim 40, wherein said telecommunications signal is received by said smart phone which further permits browsing of remote information resources such as web page links.

44. The method according to claim 40, wherein said browsing by said smart phone remote information resources comprising means for receiving said active message and means for extracting and displaying said content summary for said one or more information resources.

45. The method according to claim 40, wherein said message comprises a summary of the content of one or more information resources to which said smart phone is connected via an internet, and links specifying the location of each of said information resources.

46. The method according to claim 40, wherein at least one of the following holds true:
a. said method further comprising step of deriving calls from any utilized system to a cellular system;
b. said method further comprising step of directing said caller by said message to a predetermined GUI providing video, audio picture, GPS or a related interface or context to said URL; and
c. said method further comprising step of providing said URL automatic opening of an active website in a form of a pop up site.

47. The method according to claim 40, wherein said method further comprising step of providing active message for a wireless receiver, comprising a pre-installed template.
